(19) United States
(12) Patent Application Publication
(10) Pub. No.: US 2004/0111360 A1
(43) Pub. Date: Jun. 10, 2004

(54) SYSTEM AND METHOD FOR PERSONAL AND BUSINESS INFORMATION EXCHANGE

(76) Inventor: David Albanese, Los Angeles, CA (US)

Correspondence Address: DALINA LAW GROUP, P.C., 7910 IVANHOE AVE. #325, LA JOLLA, CA, 92037, US

(21) Appl. No.: 10/604,355

(22) Filed: Jul. 14, 2003

(51) Int. Cl. G06F 17/60

(52) U.S. Cl. 705/38; 705/1

(57) ABSTRACT

This invention pertains to the field of personal and business information sharing. More particularly, it relates to enabling personal profile matches between separate users of a communication service, purchase method or loyalty program, taking into account geographic location and configurable time delays. The invention provides non-profit or for-profit businesses and retailers with expanded customer information through an interdependent exchange, in which businesses gain the ability to mine, analyze, and make decisions based on voluntarily provided customer information, and in return users gain the ability to match profiles and make new friends or contacts. Profiles may include dating preferences, employment, items for sale or trade, feedback, emergency information, languages spoken, and all other forms of information that relate to the capabilities and needs of an individual, as well as a complete record of all goods and services a user buys while using this invention

### BACKGROUND OF INVENTION

1. Field of the Invention

Embodiments of the invention described herein pertain to the field of computer hardware and software. More particularly, this invention offers an improved mechanism for enabling users to exchange personal and/or business information.

2. Description of the Related Art

Current loyalty programs and purchase methods, such as debit and credit cards, do not allow participants to exchange personal infNormation. Therefore, when using these devices, there is no possibility of notifying a person that another closely located individual has a shared resource or need. Communications services such as those utilizing cell phones and wireless PDAs are another interface between a person and a business since the user is paying the business for the privilege of using the service. All of the aforementioned programs, methods and services are vying for the customer”s loyalty with incentives and discounts. Communications services do allow users to directly communicate by voice or text, but do not readily allow users to provide personal information profiles that can be matched with programmable time delays, autonomously on the device itself, by ignoring the geographic location for the match or with loss of the coverage for the primary communication signal. For example, someone making a purchase in a store may be looking for a job and someone who just purchased something in a nearby or distantly located store may be offering a job in the same line of work in the same geographic area. Current communications services, loyalty programs and purchase methods do not allow nearby and distantly located individuals to interact based on personal information or needs that are common to the individuals.

The amount of information gathered by providers of communications services and purchase and loyalty programs is currently very limited and is difficult to elicit from patrons who are ever wary of providing their personal details to corporations whose needs and uses of the information are suspect and whose security measures are unknown. The appeal for retailers to data-mine portions of the purchase history and personal profile information and make better business decisions via a subset of this expanded information is undeniable. What past inventions have failed to do is give their participants an incentive to provide personal information. These inventions concentrate on maximizing the amount of money that can be extracted from the patron, and all fail to consider that individual person”s social needs. Therefore, the prior inventions are self-limiting in many ways.

Dating services exist which rely on the comparison of personal profile attributes. These services are limited in many ways since they do not take the current physical location of the persons into account. In addition, they do not provide a means for mining purchase history data from a person or correlate any other types of needs that people have except dating related needs. Time delays for comparisons are not utilized.

Many possibilities arise for program participants if they were enabled to benefit from the information surrounding them in their everyday environment. Enabling people with like interests and needs to find each other, as matched by a communications service, or within a loyalty program or purchase method, whether geographically located or not, and with or without time delays, would benefit program participants greatly.

Communications services, purchase methods and loyalty programs can be incentivized in order to encourage people use them. This is accomplished with frequent flyer miles given per minute of service usage, or awarded for the amount of expenditures with mileage credit cards, or via loyalty programs or any other method that allows end-users to gain discounts for using the loyalty card or device. No service or program allows for the user to choose to share more personal information for cheaper communications service, higher discounts or more benefits. Notwithstanding the monetary incentives, there would also be an incentive for people to provide personal information if they knew that they could find other people with similar interests and needs by providing this information. No services, methods or programs currently implement business models which overlap the comparing functions of personal profiles in the course of conducting their businesses. The businesses that perform limited matching provide no means to mine the purchase history or other profile data for the benefit of the business while providing the matching functions for the benefit of the patrons.

In U.S. patent application No. 20020075151, “System and method for transmitting messages from a guest to another party at a coverage area”, the inventors describe an invention that consists of an RFID based kiosk system requiring a user to go to a kiosk, where their RFID is read, enter a message that is transmitted from the kiosk to a central server, then requires a second user to go to a kiosk, where their RFID is read, in order to receive the message then downloaded to that kiosk. In essence this is a cumbersome method of sending messages, and in essence substitutes an RFID for an email address. There is no provision in the application for correlating personal profiles with or without time delays, accessing loyalty information, purchasing products, searching for jobs, or accessing coupons. In addition there is no means of performing any of these functions based upon how geographically close someone is since all users of this system by definition are collocated. Therefore no one can be excluded.

In U.S. patent application No. 20020077883, “System and method for accumulating marketing data from guests at a coverage area”, the inventors describe a system that reads RFID tags in order to accumulate purchasing and attendance information and stores that information in a central server. Applications for the invention include reservations for amusement park rides to avoid waiting in lines, point-of-sale applications whereby the user purchases an amount of credits that are identified by the RFID, and attendance figures for various rides. In short, this is the classic RFID application requiring identification only, and no processing or autonomous operation of the end user device. There is no provision in the application for correlating personal profiles with or without time delays, accessing loyalty information, searching for jobs, or accessing coupons. In addition there is no means of performing any of these functions based upon how geographically close one person is to another.

In U.S. patent application No. 20020082920, “System and methods for providing a multi-merchant loyalty program”, the inventors describe a system for aggregating loyalty programs into a single master loyalty program, yielding points or coupons for later use. This system attempts to simplify the process of using loyalty cards, and does so by associating a credit card or master loyalty card with a given user instead of an RFID. There is no provision in the application for correlating personal profiles with or without time delays, searching for jobs. In addition there is no means of performing any of these functions based upon how geographically close two people may be.

In U.S. patent application No. 20020156861, “Information exchange between non-networked devices through an intermediary device via a piconet”, the inventor describes a method of initiating network communications between mobile devices. There is no provision in the application for correlating personal profiles with or without time delays, accessing loyalty information, purchasing products, searching for jobs, or accessing coupons. Indeed the sole purpose of the application is to facilitate low-level communications channels between mobile devices.

In U.S. patent application No. 20020165758, “Identification and tracking of persons using RFID-tagged items”, the inventors describe a method and system for identifying and tracking persons carrying RFID-tagged items as opposed to a single RFID badge or ID, and using correlation algorithms as to the items being carried, determine who that person is. Also, the system tracks the movement of a person within a store and can provide targeted marketing information to that person. The focus is the store, not the person. There is no provision in the application for correlating personal profiles with or without time delays, accessing loyalty information for that particular person since the correlation algorithm may not provide an exact match, purchasing products, or searching for jobs or other items for sale from other individuals that may be in the store.

In U.S. patent application No. 20020188509, “System and method for networked loyalty program”, the inventors describe a system and method for implementing a network-wide loyalty program whereby purchases are analyzed for marketing purposes, the invention also allows for the creation of a purchasing profile. There is no provision in the application for correlating personal profiles with or without time delays, accessing loyalty information from a user device, purchasing products, or searching for jobs. There is no distinction made in the program based on geographic location. In addition, the profiles are limited in nature and static after initial setup.

In U.S. patent application No. 20020194049, “Computer-based networking service and method and system for performing the same”, the inventor describes a networking tool for on-line facilitation of meetings between individuals at specified time ranges at a specified region. The invention contains dependent claims relating to filtering invitees by profession, employer, salary, restaurant preference, etc. There is no provision in the application for correlating personal profiles with or without time delays, accessing loyalty information, purchasing products, searching for jobs, or accessing coupons.

In U.S. patent application No. 20030093405, “System and method for searching, finding and contacting dates on the internet in instant messaging networks and/or in other methods that enable immediate finding and creating immediate contact”, the inventor describes an internet based instant messaging dating system enabling immediate communications. The invention enables searching based on education, appearance, attitudes, personality, and reciprocal compatibility of these and other attributes. The invention allows for searching even if users are in a non-connected state. There is no provision in the application for correlating personal profiles with time delays, a geographic point of reference, accessing loyalty information, purchasing products, searching for jobs, or accessing coupons.

In U.S. patent application No. 20030103644, “System and method for directed advertising”, the inventor describes a method of presenting advertisements after detecting the identity of a collocated user. The filing date of the application is Jul. 30, 2002 while the release date of the movie “Minority Report” was Jun. 17, 2002. This movie showed an advertising system that used visual image recognition to target advertisements at specific people. Although capable of identifying a patron, there is no provision for correlating personal profiles of other patrons within or outside the geographic area of the store, or for enabling purchasing of products or searching for jobs or any other type of supply, need, capability, compatibility, or service of other patrons.

In U.S. Pat. No. 5,086,394, “Introduction system for locating compatible persons” the inventor describes a paging system for comparing personal characteristics and paging people that match. The invention allows the use of IR, radio, telephone, ultrasonic and encoded card entry of personal and identification data into the pager. The system prevents re-comparing of previously matched pairs. There is no provision in the application for correlating personal profiles with time delays, accessing loyalty information, purchasing products, searching for jobs, or accessing coupons. The pagers are not used in order to determine a location for the user in real-time and it appears that the user must dial in and inform the system if the user is in a different location for a period of time.

In U.S. Pat. No. 6,052,122, “Method and apparatus for matching registered profiles”, the inventors describe a system for comparing users characteristics and notifying the users of a match. The invention is web based and describes a large number of characteristics upon which a match is attempted. There is no provision in the application for correlating personal profiles with time delays, accessing loyalty information, purchasing products, searching for jobs, or accessing coupons. The invention cannot consider the current physical location of a user since there are no means contemplated of tracking the users with devices since everything relating to the invention is web-based.

In U.S. Pat. No. 6,119,933, “Method and apparatus for customer loyalty and marketing analysis”, the inventors describe a system using customer identification in the form of a credit card, government-issued ID, checking account number, biometric input device or smart card or any of these objects in common with a given user, in order to identify the user at a point-of-sale device at a retail outlet. The data is sent to a data warehouse at periodic intervals in order to analyze. The system also allows users to interact with their information on the internet. The inventors also contemplate use of a smart card in order to save customer preferences or frequency of visits, or award points. There is no provision in the application for correlating personal profiles with or without time delays, purchasing products, searching for jobs, or accessing coupons.

In U.S. Pat. No. 6,243,687, “Kiosk systems and methods for issuing a card storing electronic coupons, after receiving data about a customer”, the inventor describes a card-dispensing kiosk that downloads coupon information into a smart card after a user completes shopping. The user then presents the smart card to the vendor upon purchasing something and the coupons are deducted from the smart card. There is no provision in the application for correlating personal profiles with or without time delays, accessing loyalty information, purchasing products, or searching for jobs.

In U.S. Pat. No. 6,272,467, “System for data collection and matching compatible profiles”, the inventors describe an automated method for identifying matches between a set of predetermined set of preferences. The invention is contemplated for personal and employment matches. The algorithm is a two-way matching algorithm which ensures that both sides of the match are satisfied customers. The invention can adapt based on past matches and adjust parameters for the matching algorithm. The algorithm can adjust parameters based on user size to form normative build data that represents a user”s build rather than an absolute weight or height for comparison purposes. There is no provision in the application for correlating personal profiles with time delays, accessing loyalty information, purchasing products, or accessing coupons. The invention does not take into account the current physical location of the customers and has no means in which to calculate location parameters.

In U.S. Pat. No. 6,336,098, “Method for electronic distribution and redemption of coupons on the world wide web”, the inventors describe a method and system for distributing and redeeming coupons on a computer network. The invention uses downloaded files that are later entered into web sites for use as digital coupons. No attempt to download coupons to a mobile device is considered. There is no provision in the application for correlating personal profiles with or without time delays, accessing loyalty information, purchasing products, or searching for jobs.

In U.S. Pat. No. 6,434,158, “Entryway system using proximity-based short-range wireless links”, the inventors describe an entryway system consisting of a personal presence identifier, a guest and a door entry system. The invention determines whether the personal presence identifier is authorized for communications before allowing the exchange of information to determine whether or not the user is allowed entry. There is no provision in the application for correlating personal profiles with or without time delays, accessing loyalty information, purchasing products, searching for jobs, or accessing coupons.

In U.S. Pat. No. 6,449,684, “Data carrying device and systems for use therewith”, the inventors describe a device configured to hold data, such as a smart card. The invention contains programs relating to electronic purse or other payment systems, loyalty and incentive programs, electronic tickets, memberships, access control and authentication, merchant ID, terminal ID, host phone number. It also appears that the invention requires a terminal reader since no means of networks between smart cards is contemplated. The invention is strictly an aggregator device. There is no provision in the application for correlating personal profiles with or without time delays, searching for jobs, or accessing coupons. There appears to be no mention of geographic location for use with the invention.

In U.S. Pat. No. 6,549,768, “Mobile communications matching system”, the inventor describes a system for matching profiles of users of a wireless network using the ID of the mobile phone. The server is utilized in order to perform a customizable variable matching algorithm. If a match occurs, the two persons are put in contact with each other through a phone call or other communications method. The persons can be tracked and the match can be performed on users geographically collocated. However, they must be within an area that has cell phone coverage. There is no provision in the application for correlating personal profiles with time delays, accessing loyalty information, purchasing products, searching for jobs, or accessing coupons.

A device known as the “nTag”(™), is a device that contains an IR input/output port for 3-5 feet range for “beaming” contact information between conference attendees, an RF link to a central server in the conference, 128k memory, and an LCD text area that flips to the correct orientation when the badge flips so it can be read by the wearer. The nTAG has enough memory to hold conference sessions, and also contains buttons for beaming and responding to instant polls given at the conference. The device also contains an RFID in UHF band, and can track areas of conference floor that have been covered by the wearer of the badge. There is no provision in the device for correlating personal profiles with time delays, accessing loyalty information, purchasing products, searching for jobs, or accessing coupons.

A software loyalty program found on EastBiz.net, which contains no name other than “Loyalty Programs” is directed at loyalty programs for e-business websites, and offers the ability to meet other people associated with the program. There is no provision for correlating personal profiles with time delays and it appears that there is no provision for matching any other type of profile, such as employment or “items for sale” that a user has to offer. There appears to be no means for geographical determination of which users are close to one another or any means for allowing them to contact each other than via text based messages.

### SUMMARY OF INVENTION

Embodiments of the invention allow persons interacting with a business, such as a communications service, a purchase method or a loyalty program, to provide personal profile information that can be compared using various algorithms to the personal profile information of other members of the service, method or program. In some instances this comparison is customized to take into account the geographical location of the interaction between persons and uses configurable time delays for comparing different portions of the profiles. Some examples of the profile types or categories of information that the system is configured to share include, but are not limited to employment, dating, for-sale, wanted-item, purchase history, loyalty, feedback, and coupon profiles. Each profile contains related items within that category. An example of some items inside a category would include store name, purchase date, bar code, quantity and amount for each separate purchase in the purchase history profile. The feedback profile can provide a way for other users of embodiments of the invention to have the capability of deriving a level of trust for a user based on the feedback from prior contacts with other users. Certain profiles may be unalterable by the user, such as the purchase history profile in which businesses place receipts of purchase in certain embodiments. The profile should not be able to be copied into another consumer device since it represents the purchase history of a given user and since it represents confidential information that would be of only marginal utility to a another user.

The comparing process can be, but is not required to be, geographically constrained to a specific location. Each parameter of each profile can be separately set for different geographic matching. For instance a comparison may be related to a set of exact store locations a person has visited, or encompass all store locations (i.e., loyalty-program-wide in scope as opposed to geographic in scope, or based on the current physical location of a user of a communications device. In other instances the comparing process ignores the geographic locations of elements of the profiles depending upon settings in the profiles themselves. The comparing process can also be performed for a loyalty program specific to a given store, group of unrelated stores within a multi-store loyalty program, or unrelated loyalty programs that are affiliated with an embodiment of the system. The comparing process can be performed at the point-of-sale, within the user”s electronic device, or on a server configured to provide a personalized web page for a specific customer and can be performed with configurable time delays.

Time delays may be associated with individual portions of the profile. For example, the system may disable comparing functions for certain aspects of a dating profile until more than 8 hours after a transaction occurs while allowing immediate comparing of the buy profile. An example of this would be in the case of a user wanting to find a collectible, but not being in the mood for socializing. Note that the specification of 8 hours is an example only and can be any number. This is only one example of many reasons why a time delay would be placed on a certain profile or individual item within a profile. Time delays may provide a measure of safety, or may be used in order to delay comparing a portion of a profile for any other reason. Time delays can be specified without any upper or lower limitation. After a user has made a match, embodiments of the invention allow the user to keep abreast of the profiles of the other user forever after initial contact. Other embodiments of the invention may filter the user after a certain time period. The user may bar or block another user from accessing the profile regardless.

An embodiment of the system comprises a device, a device reader, a network connection and a server. The device can comprise a purchase method device, loyalty device or communications device. The purchase method device comprises a RFID enabled device, bar code, credit card, debit card, cash card or biometric input as in a thumb print, retinal scan or other body measurement. The loyalty device comprises a loyalty membership card or membership number. The loyalty device may be for an existing loyalty program or associated with an embodiment of the invention as a standalone loyalty program. The communications device comprises any device capable of communication outside of the business including, but not limited to a cell phone, PDA or text messaging device or any combination thereof. The device associates a user with a service or purchase, and may also associate that service or purchase with one of many loyalty programs that the user may belong to. The device reader is any device capable of reading the device and transmitting the information thereon to the server. The device reader comprises an RFID reader, bar code reader, card reader, biometric input device, IR, ultrasonic or communications receiver/transmitter and may use physical or non-physical contact for communicating identification. The network connection may comprise the Internet, cable, telephone, satellite or any other WAN, LAN or wireless communications network capable of transmitting data to the server. In peer-to-peer configurations, the device readers may network to each other for backup when communications to the server is not possible or intermittent. The server is any server capable of storing the purchase locally, or externally via any other coupled server, comparing the personal profile of the purchaser to all other purchasers within that store, within all stores in a given multi-store loyalty program, or within all of the loyalty programs that the user belongs to. The server performing the comparison can utilize or ignore the geographic location of the two users depending upon the portions of the geographic settings in their profiles. These settings signify whether geographical checking should take place, and if so, how close the users have to be located to each other in order for a match to occur.

Another embodiment of the present invention utilizes a comparing server separate from each server coupled to device readers, allowing user access to the comparing server via the internet. This embodiment keeps private information in a place separate from the companies, and allows the companies to only get at data that they are allowed to see in order to prevent them from gaining access to extremely private information such as sensitive dating preferences. In addition, another embodiment of the invention allows the companies to only send the user identification to the comparing server possibly along with a date, time and location to further enhance the comparing process, this embodiment allows users to provide their personal information once and only once and utilize the comparing function over as many communications services, purchase methods and loyalty programs that the person uses or is enrolled in.

An embodiment of the present invention utilizes existing RFID based devices, such as SpeedPass®, or any other RFID enabled device in order to signify that a user has purchased something. This allows the device to remain small. The store location, time of purchase and unique ID of the person are stored in the purchase server or loyalty program of the given store or program. The comparing function is then performed on the transaction in order to determine if there are any fellow loyalty program customers that have visited that store, or have bought anything store-wide or loyalty-program-wide that have the same interests or needs of the profile of the purchaser. Emails or phone pages, text messages, web page displays, or any other form of communication can be then utilized in order to inform someone of a potential profile match. The user informed of the match may then contact the other user in order to interact with that individual. Users may block access to users that they do not wish to interact with at any point in the future.

The device itself or device reader may communicate with the purchaser in order to ask the purchaser for their zip code entry, password, or any other authentication methodology or biometric input for security purposes. Biometric input could include a fingerprint reader on the device or device reader. Since there is more information associated with the device, albeit possibly not directly on the device as in the case of RFID based devices, it is possible to protect access to interactions with the device in case of theft or loss of the device. Generally, RFID devices can be disabled immediately by phoning the appropriate issuing authority in order to disable interactions with the device, and also flag illegal or unwanted uses of the device.

The device or device reader may also communicate with the purchaser allowing them to determine which of multiple credit or debit sources the transaction should be associated with, meaning that the transaction could conceivably make use of multiple available loyalty programs independently or in combination in order to perform the correlations.

An embodiment of the invention may access a person”s loyalty accounts in order to retrieve the purchaser”s digital coupons for use in the transaction. Also, the user may pay with electronic cash and simply choose a loyalty program to associate with the transaction, or if the transaction can be completed using only coupons, then no electronic cash or credit card transaction would transpire yet the loyalty program may register the interaction.

A communications device such as a PDA or a cell phone may also possess device capabilities, such as Infrared, WiFi, Bluetooth, ultrasonic, or other signaling means that allow for the transmittal of an identifier that identifies the purchaser to the device reader associated with the point of sale system. Embodiments of the present invention may utilize any identifying device in order to associate a profile set with a person.

In this case, the communications service could be independently performing profile matches for persons in the area, while a purchase method could be independently performing matches while the loyalty program chosen for the transaction could be independently performing matches for patrons of the loyalty program. Comparing functions could in this case be performed simultaneously on multiple devices with their associated profiles, and within multiple servers using geographic and time delay parameters of profiles being compared. All matches can be displayed either on the communications device or on the internet for later perusal.

The profile for the end-user can contain information as to the needs and wants of the user including desired dating, employment, shopping needs and wants for one-way or two-way comparing functions. In short, anything that a person has or needs can be specified and classified in a manner that will permit correlation and subsequent contact if mutual compatibility has been determined. The profile may be accessible for local configuration, or indirect configuration such as on-line configuration via a browser or any other user interface methodology including but not limited to phone based configuration via speech recognition. A profile may be considered a category within which information exists relating to that category.

The purchaser may also be presented with the option of selecting a greater discount for a larger sharing of personal information with the seller, which may be facilitated in real-time or after-purchase, by garnering a quality score for the amount of information from the loyalty program before being allowed to access the actual information bartered for via the discount. As the purchase history of the individual may include purchases from competitor stores, the purchase history profile may be extremely valuable to the store. The personal profile data such as items for sale and jobs that the person is seeking may also be bought by the store, or the user may obtain a larger discount for providing this information as well. The information can be accessed by the point-of-sale via the device, at the central server for the business, as for a purchase server, or over a network such as the internet, at the comparing server.

Embodiments of the invention may be worn on person in such a manner as to advertise use of the technology. Other embodiments of the invention may be key fobs in the case of RFID devices, or credit card sized wallet devices that do not even have to be taken out of the wallet in the case where they are RFID enabled. Cell phones, PDAs, Blackberry devices or any other device that may be worn on the outside of a persons clothing may bear a logo or text trademark that signifies that they are members of the system, although this is not required.

An embodiment of the invention comprises a purchase or comparing server that can be clustered in order to provide required processing power. In addition, middleware such as EJB, CORBA or various Microsoft technologies can be utilized in order to connect the purchase server to other purchase servers, comparing servers, or loyalty programs for transparent interoperability. Any middleware that allows interoperability between communications service servers, purchase method servers or loyalty program servers, and a server performing the profile calculations including web services, EDI or any other type of middleware can be utilized.

An embodiment of the invention comprises GSM, GPRS, EDGE, CDMA, UMTS or any other radio frequency communications medium including but not limited to WiFi, Bluetooth, Wireless, IR, or other previously mentioned communications techniques with comparison on the autonomous device. This technique allows for immediate comparison of profiles of other devices in the geographic vicinity on the autonomous device without need for accessing a purchase server. The user does not have to make a purchase to utilize the system. The advantage is that the comparing operations can be done immediately and the user can be immediately aware of persons with similar needs or supplies within the immediate area, notwithstanding the configurable time delay that other customers may have set in their profiles. This does not require cell phone coverage as a cell phone or PDA with telephonic capabilities may switch over to WiFi or Bluetooth or any other wireless or connection based technology in order to transfer data during phone coverage loss, or may be working at the same time, involving comparisons with other similarly enabled devices simultaneously employing cell phone coverage. Devices such as cell phones, PDAs, PocketPCs and others are capable of performing the requisite functions by interacting with the device reader in order to obtain the required profiles via IR, wireless or ultrasonic signaling. When coverage is revived, duplicate matches can be easily handled by the devices or servers and ignored. The device may be notified if a first user has performed a business transaction with a device reader in the vicinity of a communications device associated with a second user which is in communication with a device reader comprising a router or cell phone receiver/transmitter within the configured vicinity of the first person”s business transaction. In this manner, persons not directly involved with a business transaction, loyalty program transaction or other business transaction may be alerted to a profile match from a non-communication device in the vicinity, or regardless of vicinity.

Another embodiment of the invention comprises communications devices such as cell phones and PDAs that communicate via their service providers without autonomous communications bypassing their services, yielding a system in which profile comparisons are done on the servers and not on the autonomous devices themselves even if they are capable of autonomous comparing functions.

An RFID may also be embedded within a PDA, cell phone, PocketPC or other electronic device, or not utilized at all if a digital certificate or other methodology is used in its place in order to provide a method of identifying the purchaser.

An embodiment of the invention may be utilized by an existing loyalty RFID program, adding the personal profiles, and comparison algorithms and access screens and methods to the existing program. This enables the system to be utilized within an existing infrastructure.

An embodiment of the invention that also uses an existing RFID loyalty program is achieved by allowing access from the purchase server or central server or communications server to the comparing server so that all personal information is kept outside of the loyalty program, and all business information is kept within the communications service servers, purchase method servers or loyalty program in order to provide a single point of access and configuration for the personal profile elements.

The purchaser may interact with the system using a web page or other program in order to determine what types of matches transpired during their latest travels, including shopping expeditions. The individual loyalty program or the aggregate loyalty program screen may be accessed in order to find the matches, or the user may access a separate web site or phone system connected to a server that is separate from the loyalty program, communications service or purchase program, as long as that server is capable of performing matches based on profiles, as would be the case for an embodiment employing a single comparing server architecture.

The store or corporate office of the store employing a loyalty purchase program can data mine and sift through purchase and personal information that has been allowed to be perused via explicit purchaser choice, in order to target marketing information, and further provide analysis of the buying patterns or predicted buying patterns for the store or area under consideration. Personal information can be encrypted so that various preferences cannot be read even by administrators of the system. For embodiments of the invention utilizing a comparing server external to the business servers in the system, this is not an issue since the data that has not been explicitly allowed to be shared is deemed too personal to show to the business, and is therefore not transferred to the business.

All embodiments of the invention may comprise encryption and digital signatures in order to provide the utmost in security. RFID has its own form of encryption, as do wireless technologies.

Profiles may be kept in XML format, with a defined Schema or DTD, with portions of sensitive nature unrelated to business functions kept in Base64 or other encrypted format, or even kept in pointer format to a location where the sensitive data is kept. The profile may be entirely binary in nature as well, or in any other storage format such as a database table with various formats for various portions of the profile. Embodiments of the invention making use of Web Services may choose to rely on the XML format messages in order to maintain interoperability.

The comparing algorithm comprises one or two way comparisons and may allow for the setting of time delay on any portion of the profile. Incompatibility settings may also be applied for each portion so that a given parameter if found in the other profile yields an immediate mismatch. In addition, any portion of any profile for a user can be marked as private, so that it is not shared outside of a given server. For example, in the dating profile the parameter “smoker” can have a flag associated with it in order to completely invalidate a match if the other person smokes. If the employment profile contains a smoking property that is set without a flag for invalidation, then an employment comparison will yield a match with that very same person if the rest of the job requirements are satisfied.

### BRIEF DESCRIPTION OF DRAWINGS

FIG. 1 is a diagram of the architecture showing two purchase or loyalty devices, two device readers, a central computer and two computers connected over a network to a central computer.

FIG. 2 is a diagram of the architecture showing two communications devices, one involved in a purchase transaction, a communications receiver, a communications service server and a computer connected over a network to a central computer.

FIG. 3 is a diagram of the architecture showing two communications devices, one device reader, a central computer, a communications service server, and a computer connected over a network to a central computer and a comparing server.

FIG. 4 is a diagram of the user interface running on a computer which is utilized in order to configure and interact with the system and personal information matches of other users of the system.

FIG. 5 is a diagram of the store interface running on a computer that is utilized in order to analyze the purchase history of users of the system.

### DETAILED DESCRIPTION

Embodiments of the present invention allow persons interacting with a business, such as using a communications service, a given purchase method or a loyalty program to provide personal profile information that can be matched using various algorithms with other members of the service, method or program, taking into account the geographical location of the interaction and using configurable time delays for comparing different portions of the profiles. The resulting service information, purchase information or other business information including desired personal purchase history profile information may be mined by a business.

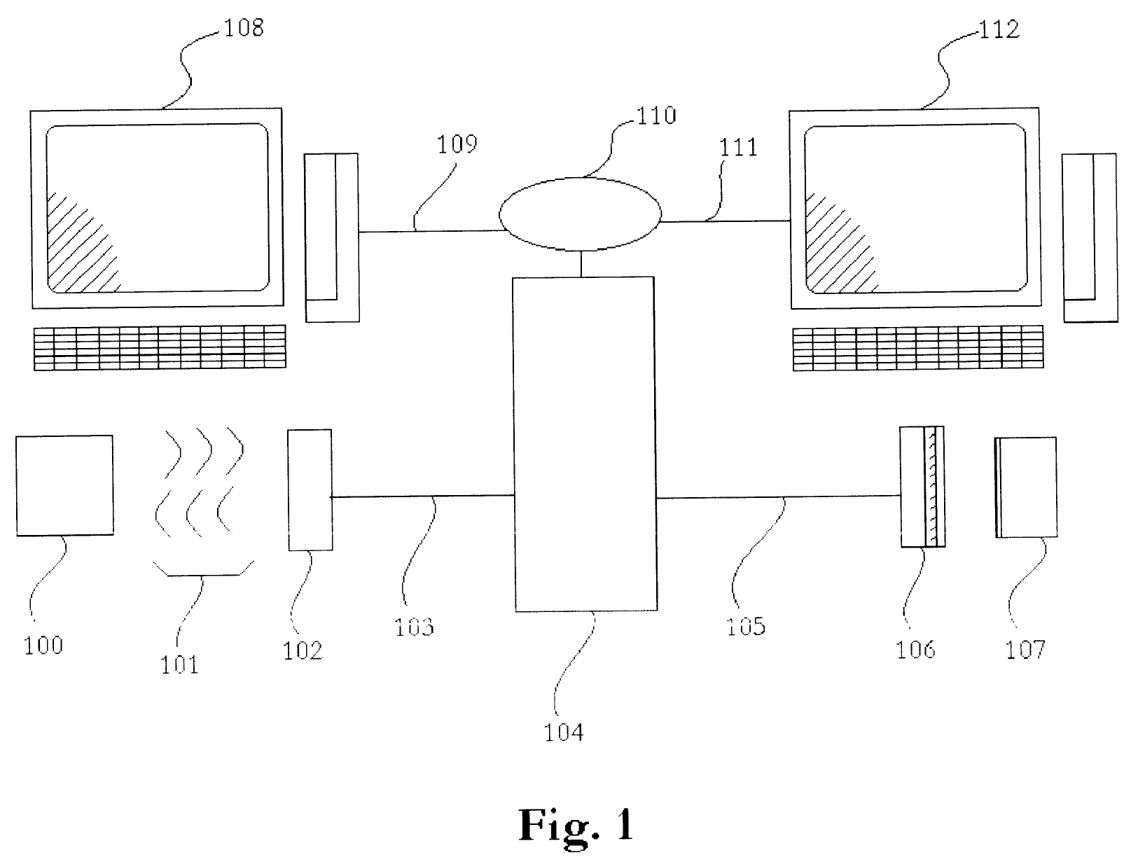

FIG. 1 shows an architectural view of the system. Device 100 communicates indirectly with device reader 102, via signal 101. Device 100 may comprise a communication service enabled device, a purchase method device such as a credit card, debit card or cash card, or a loyalty program card. Signal 101 may utilize Radio Frequency (RF), Infrared (IR), Ultrasonic (US), or any other type of signaling means that enables an identifier of the purchaser to be negotiated between device 100 and device reader 102. Signal 101 may be encrypted in order to provide a measure of security. Device reader 102 receives the identifier and transmits the identifier and any purchase good descriptions and quantities to central server 104 over communications line 103. Device reader 106 is a physical reader, being either a biometric input device or magnetic swiper for credit cards or smart cards and also communicates to central server 104, over its own communications line 105. Device reader 106 may or may not be located in the same store as device reader 102. Communications lines 103 and 105 may utilize any type of communications protocol and medium possible in order to transmit the information, including but not limited to TCP/IP over Ethernet. Communications lines 103 and 105 may be encrypted in order to provide a measure of security. Central server 104 may be a mainframe or cluster of redundant enterprise level servers or any computer system large enough to handle the load of users accessing it via all attached device readers and computers. Computers 108 and 112 access network 110 over communications lines 109 and 111 respectively. Communication lines 109 and 111 may utilize a phone line in the case of a modem connection, or a cable line in the case of a cable modem connection, or a wireless link in the case of a WiFi connection, or any other form of communication known in order to access central server 104. Network 110 may comprise the internet. Computers 108 and 112 are utilized in order to access matches, configure personal profiles, communicate with persons with whom a match is indicated, and are also used by stores in order to garner information in which to better serve users of the system. Any number of devices, device readers, computers and networks may be utilized in the system.

FIG. 1 shows that device 100 need not be physically connected to device reader 102. RFID devices are currently available that allow purchases to be made against a single credit card. SpeedPass® is an example of this type of use of RFID. Embodiments of the present invention allow the user to select a credit card for the transaction and selection of the specific loyalty program in which to apply the transaction since more than one could be involved if a store is part of a multi-store loyalty program and has its own loyalty program or is using a third-party standalone loyalty program internal to an embodiment of the invention. Also, credit cards themselves have a rewards program that is automatically selected by using that particular credit source in the transaction. In addition, before the actual transaction is allowed, and before any comparing operation is performed, device 100 may be accessed in order to authenticate the user via zip code, biometric or password input or any other authentication methodology. Embodiments allowing this type of authentication utilize a stylus, button, key or other type of user input for selecting numbers and letters. Examples would include PDAs, PocketPCs, cell phones or any other device allowing for selection amongst various options. The selection of credit card from a list and loyalty program from a list of possibilities may be invoked on device reader 102 for embodiments employing RFID based device 100.

Emulators of RFID devices, containing the encryption algorithms and responding with the correct output codes are also contemplated for use in PDAs, PocketPCs and cell phones allowing for selection between various RFIDs electronically. This would allow a single RFID emulator to take the place of multiple separate RFID devices, or key fobs, in order to minimize the size of one”s key chain.

Devices allowing for the transfer of electronic cash may also be used within the system, and can be involved in comparing operations as long as they provide a way of identifying the user. Pure cash transactions are untraceable and the store gains no information as to the customer involved in the transaction and the customer has no way of comparing with other customers unless they identify themselves.

For devices with memory, digital coupons can also be downloaded at the time of purchase and used in the transaction.

Device 100 may query the user for input as to the amount of information desired for sharing, based on the level of discount offered, by sharing more personal information, except data marked as private, a user may be persuaded to offer more information to get more of a discount. If not selected at purchase time, the purchaser may decide later to opt in for this discount via computer 108 and receive the credit to the account from which the transaction was originally deducted.

The device may contain a stylized brand logo, name, color or other distinctive look and feel in order to further inspire people to sign up for the service.

Comparisons may be performed on device 100 if the device has local storage and processing capabilities, or may be performed on central server 104. Comparing data on device 100 may demand a high data rate connection for signal 101 when accessing profiles from device reader 102, or may allow very low rate communications when comparing individual profiles on two separate devices. The comparison takes into account the appropriate time delays as set by the user. The time delays allow for a margin of safety when in an environment where other people can match personal information and invoke an interaction. The time delay has no upper or lower limit.

Other embodiments of the invention use physical contact as in device 107, containing a magnetic strip in the case of a debit or credit card, or electrical contacts in the case of a smart card.

Signal 101 may consist of Radio Frequency energy at various wavelengths and power, or may comprise Infrared frequency light beams, or any other frequency of light that is capable of transferring data. The signaling technology can also be ultrasonic, or any other frequency of sound that is capable of transferring the data required for the system to operate. As long as device reader 102 and 106 can communicate with device 100 and 107, the system will operate correctly. Encryption of signal 101 makes the system more secure, yet is not required for the system to operate.

Device reader 102 and 106 may be combined in order to form a universal device reader that is capable of handling transactions involving any type of card, PDA, PocketPC, cell phone, or biometric input. Regardless of interface type, before the actual transaction is allowed, and before any comparing operation is performed, device reader 102 and 106 may be accessed in order to authenticate the user via zip code, biometric or password input. Embodiments allowing this type of authentication utilize a stylus, button, key or other type of user input for selecting numbers and letters. Device readers may be collocated within a point of sale terminal. The device readers may allow users to select between multiple payment sources associated with the purchaser, or select a loyalty program to which a transaction may be applied.

When the purchase takes place, the identifier associated with the user is transmitted as part of the transaction and in return, comparing is performed for all users that have bought something in the store, multi-store loyalty program, or loyalty-wide program within a user selectable time delay period before or thereafter. If the user walks through the store and a device reader registers that they have left the store without purchasing anything, the matching process may still occur. The proper matches are accomplished using user settable time delays that are specific to each quantity in each profile of each customer, and take into account similar interests, employment opportunities, and other personal profile comparing possibilities in order to open opportunities for users of the system. This correlation facilitates the discovery of a commonality of interests and thus offers the two users the possibility of making a personal introduction based on this filtered information. Simultaneously, as both of these users share common elements of their personal profiles, the store or businesses may collect each of the users purchase profiles and those same elements of each user”s personal profile that they are willing to share with one another. For computationally powerful devices, the profiles can all be downloaded immediately and computation initiated for profile comparison in real-time. At a later time, the user may have the ability to access more information, on computer 108, as more people shop at the store where the transfer of information occurred. None of this transfer is dependent on any of the users having to make a purchase when they were present.

Central computer 104 may comprise a cluster of enterprise level multi-cpu servers with large disk farms that are capable of online transaction processing and data mining. In addition, the comparing algorithms are performed for the gain of the users, and are performed as wide in time and geographic location as both profiles permit. Central computer 104 may interface to another such computer for a different loyalty program or a redundant computer involved with the same loyalty program to provide a measure of robustness. Any size of computer 104 can be used in the system, with greater scalability provided by architectures that utilize higher input connection speeds, lower latency lines, and more powerful computational units.

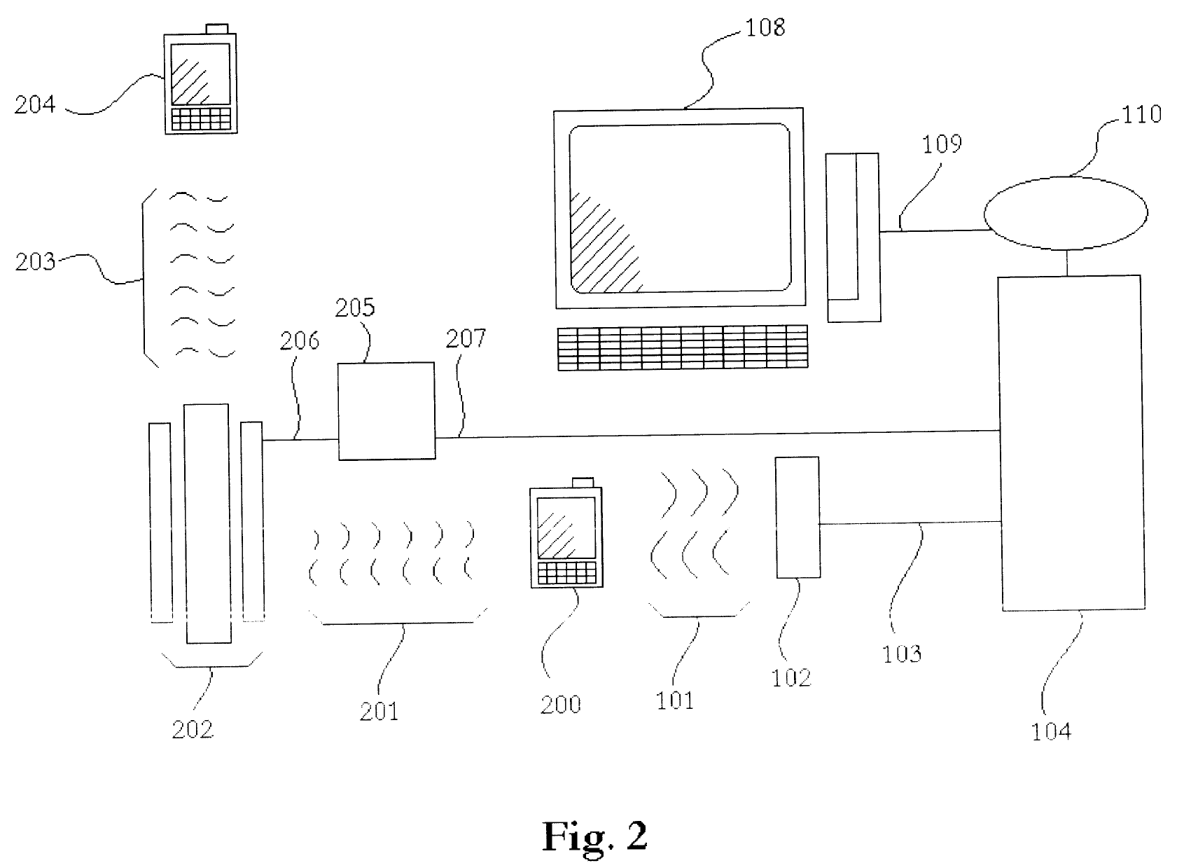

FIG. 2 shows communications device 200, with RFID, RF, light or sonic purchasing signal 101 in a transaction with device reader 102. The communications device represents any electronic communications device including PDA, PDA with cell phone access, cell phone, text messaging or any other communications device. Communications device 200 may contain biometric input on the device, or request a zip code or password or authenticate the user in any other way in order to complete the transaction. In addition, the selection of credit card type, cash, and loyalty program may be performed on communications device 200, or may be selected on device reader 102.

As the transaction takes place, communications device 200 may be simultaneously linked to the communications network via signal 201 as sent and received from communications antennae 202, which could be a cell phone tower or any other type of communications receiver/transmitter or link including but not limited to a WiFi receiver/transmitter or wireless router or hub. There are many techniques available to determine the position of communications device 200 from signal 201 as triangulated from a plurality of communications antennae 202. Triangulation has been in existence at least since World War I as a method for determining the positions of submarines. When profiles have been set with sufficiently low time delays for comparing functions, central computer 104 may initiate a request to communications server 205, over communications line 207, in order to inform it that there has been a profile match and to initiate communications to communications devices 200 and 204 in order to allow the users to contact each other. The profiles of the individuals may be set in order to allow this particular match type within the profile to alert them if someone is in their vicinity, or not. If the communications server determines that the two individuals are close enough related as per the profile settings, or if communications device 204 purchased something within the same time window, at a store closely located to the location of device reader 102, then it may initiate communications via signal 201 to communications device 200 and signal 203 to communications device 204, which may or may not be an identical type of device. The communications to the devices can be in the form of beeps, vibrations, or direct phone calls either with voice generated messages or with either a third party conduit who mediates the session, or directly to the other person with a introductory message informing the parties as to the nature of the profile match before connecting them. If communications device 200 is a PDA, a GUI can show the exact profile match on the screen, allowing the user to accept a call or send it to voice mail or to a text message inbox. A text message device or other device may default to text message utilization as the primary technique in which to communicate. The profiles may be set in order to initiate the communications link between communications devices 200 and 204 regardless of the location of the two parties using the devices as well. Communications link 207 may comprise any type of direct or indirect connection to central server 104, including but not limited to direct dedicated link or over the internet using TCP/IP.

As users of communications devices 200 and 204 move about, regardless of their current location in a store, their profiles can also be previously or currently matched in order to inform users when they are near each other or if profiles are set for non-geographic priority, then to inform them of a match regardless of their location. The computer performing the matches in this case can either be communications server 205 or central server 104, or both. The model for utilizing communications server 205 in this manner allows for the users to obtain frequent flyer miles, discounts on phone service, discounts on communications services such as WiFi, discounts on shopping at stores at the next visit and other discounts, as an incentive for sharing a portion of the users personal information, for at least the updated purchase history profile data that the user increasingly can add to when making purchases. Since the communications service can in fact be a consumer of the consumer”s purchase profile data, embodiments of the invention can allow different businesses to bid on the consumer”s data in order to gain exclusive access to it for a defined time or for all time up to or from that point on. Since the purchase history profile data and much of the personal profile data is very valuable to businesses, there is an extra value for the businesses to offer the consumers discounts, coupons, frequent flier miles or any other incentive while performing personal profile matches with or without geographic consideration and with or without time delays as an extra motivating factor for the users to share portions of their data.

Since communications devices such as PDAs may contain IR input/output devices, they can readily be used in order to purchase goods and services with signal 101, without the need for communications signal 201 to be present. The physical or electronic receipt from the point of sale, can include a printout at the bottom of it detailing matches, or match categories from someone who has recently shopped at the store, paid with a credit card as per the credit card type, or any type, for a transaction anywhere in the world, or someone who is enrolled in a communications service, regardless of the company the other party is signed up with. This cross correlation of comparing functions can involve any company affiliated with this service and can be performed in central server 104 or communications server 205, or any other server directly running the comparing algorithms or on a server associated with an embodiment of the present invention that is accessed by multiple central servers or multiple communications servers or multiple credit card, bank card, cash card or other financial institution servers.

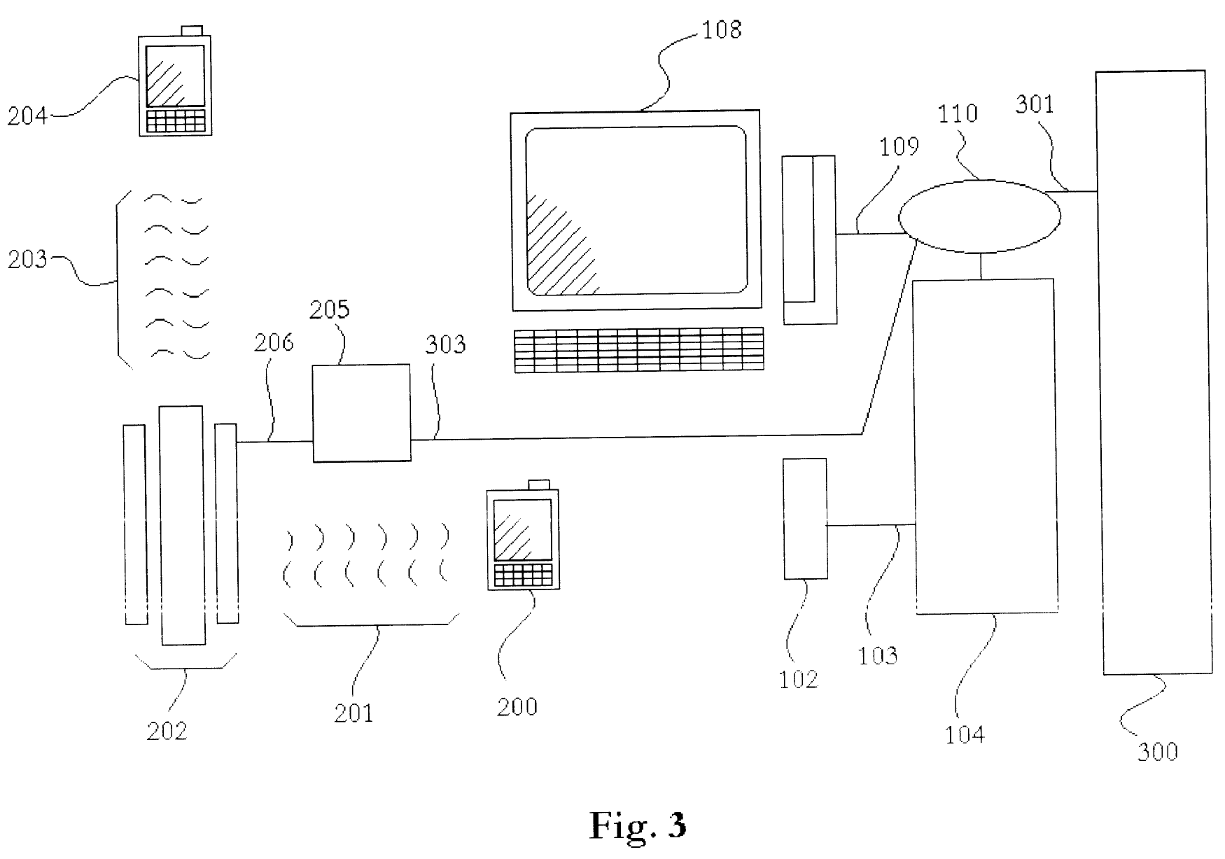

FIG. 3 shows the system for a user who has not made a recent purchase, and possesses communications device 200. The comparing algorithm may be performed on communications server 205 without accessing central server 104. Since central server 104 can be a central server for a loyalty program, purchase method, and may be store, company, multi-store or multi-company in expanse, it follows that the communications server 205 will either contain the profiles or request them from some combination of central server 104 or a master comparing server 300, or request that the other servers perform a profile match for a given user with unique identification.

Master comparing server 300 may be utilized in order to store and process matches for all users and companies enrolling in the service, or, may either accept transaction IDs over communications line 301 and associate the unique user with their profile and then perform the comparing algorithm, or may be utilized in order for companies to purchase the profiles for use on their own central servers 104 or 205. As servers 104 and 205 are not collocated or co-owned, peer-to-peer connections between them may be made in order to process profile matches with their individual users and subsequent sharing of personal information for marketing purposes. The sharing of this information may involve bartering between the companies for the information in order to gain access to the recent purchase history profile of the individual users, and since the comparing algorithm benefits the end users of the system, they are more inclined to share this information, especially when multiple companies can begin marketing their services to them, and giving them discounts and other incentives in order to allow them to access the purchase history profile and elements of the personal profile that are not set to secret. The access to the extremely sensitive information within a persons dating profile, can be encrypted, can be separately sold if the user so desires, or can be set in a profile that will never be shared outside master comparing server 300, central server 104 or communications server 205. Note that communications server can communicate indirectly to central server 104 and master central server 300 over communications line 303, which may or may not comprise a TCP/IP connection over the internet.

Configuration of the profiles can be performed using a browser or other application, and may be performed over the internet, via any attached computer, or via communications device 200 or 204. In addition, embodiments of the invention containing voice recognition and push button recognition may be employed in order to configure, enable, disable, set vacation mode, or in any other way alter the sets of profiles or elements within those profiles.

For an embodiment of the invention where the personal profile remains on master comparing server 300, communications server 205 can send a list of the users and their approximate locations to master comparing server 300 and only update the locations of users that are moving into different cell areas in order to cut down on the throughput for geographic based comparing functions. In other words, for geographic comparisons, there is no need to compare profiles that have been set for close range comparison only, if the person hasn”t entered another cell area or moved, since the comparisons performed on entry to an area have already taken place.

Any business requiring marketing information may buy the product purchase history from the service, with approval from the user, and/or offer discounts and incentives for users of the system willing to share their information. This information may include non-secret elements of the personal profile information.

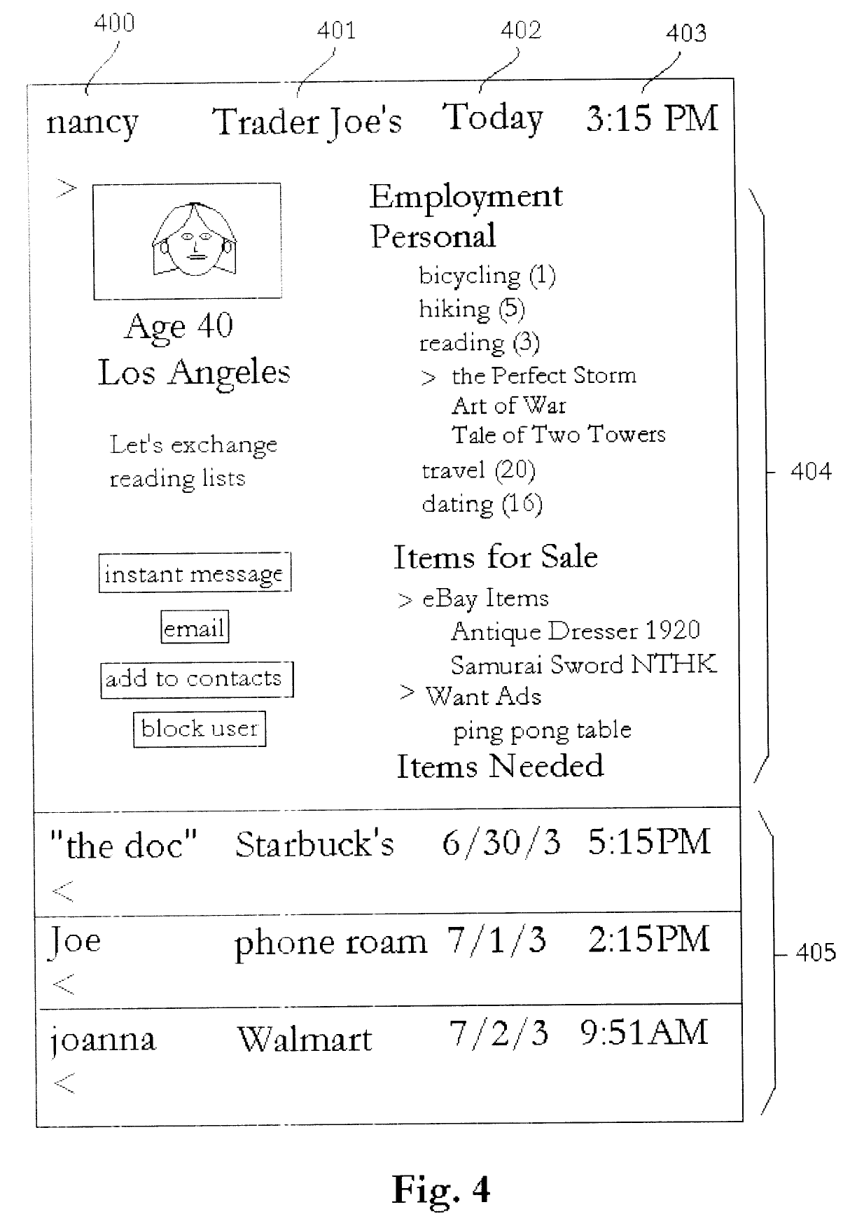

FIG. 4 shows an embodiment of the graphical user interface (GUI) that a user accesses via computer 108, via a standalone program, applet, or any other method such as by initiating a browser session and logging into the system. User name 400, store name 401, date 402, time 403, expanded user profile block 404 and a set of non-expanded user profile blocks 405 are shown on a section of a personalized web page. Non-expanded user profile blocks 405 shows a user “Joe” whose method of interacting with the currently logged in user was not by a purchase at a store, but rather by being in the specified vicinity with a communications device such as a cell phone or PDA that is network enabled. Store name 401 may further comprise a store number or address in order to more specifically show where and when the match occurred. Note that store name 401 may comprise a hyperlink or clickable banner or may comprise a clickable or printable coupon.

Multiple profiles exist on the right portion of expanded user profile block 404, including the Employment profile, Personal Profile, Items for Sale Profile, Items Needed Profile. Many more profile types may be utilized by the system, with defined parameters in each profile that can be configured from a list or entered with text information, or graphics such as pictures, audio clips, movie clips or streaming video. Also, a time delay parameter may be set for a profile or any part of a profile in order to prevent others from performing a match on that information for that period of time. Incompatibility flags may be set on parameters for matching functions, in order to eliminate someone or something from matching if it is within a set of ranges. Individual preference parameters may be marked as secret so that they are only computationally compared and are not seen by administrators of the system, or kept on a master comparing server depending upon the embodiment of the invention involved. Dating preferences may fall into this category of data that is not shared with businesses, while other preferences may be set as being shareable with the store in order to gain a greater discount, with or without the store bartering for that information. Different prices or discount levels can be selected by the user in order to allow a business to buy that portion of the profile. In one embodiment, the purchase history profile of one user is not visible to another user, however the purchase history profile is shared with businesses, although the stores may or may not perform a comparing function on the personal profiles for embodiments that do allow other profiles to be shared, or they may allow another server to perform the matches based on a unique user identification for a transaction that occurred within a given store. In addition, the user may choose to instant message a given user, or email that user or add that user to a list of contacts for further communications.

The employment profile can list jobs that the user is offering, or request a job with a given list of criteria. The employment profile may contain independent resumes for each type of job desired. The personal profile may comprise activities enjoyed or performed by the user and may comprise scores after each list item detailing the number of matches in each profile. The “items for sale” profile may comprise eBay.com listings, and Want Ad listings that the user is running, or garage sale items or any other type of sale that the user is involved with in order to allow people in the near vicinity to locate these items. These settings are useful for items that are desired to be sold locally or bought locally in the case of large antiques, or any other type of item that is difficult or expensive to transport. In addition, desired items including search lists in eBay.com format or regular expression format may be included. The dating profile can contain automatic incompatibility settings so that for example a person could say that anyone who drinks alcohol is an automatic fail for comparing purposes.

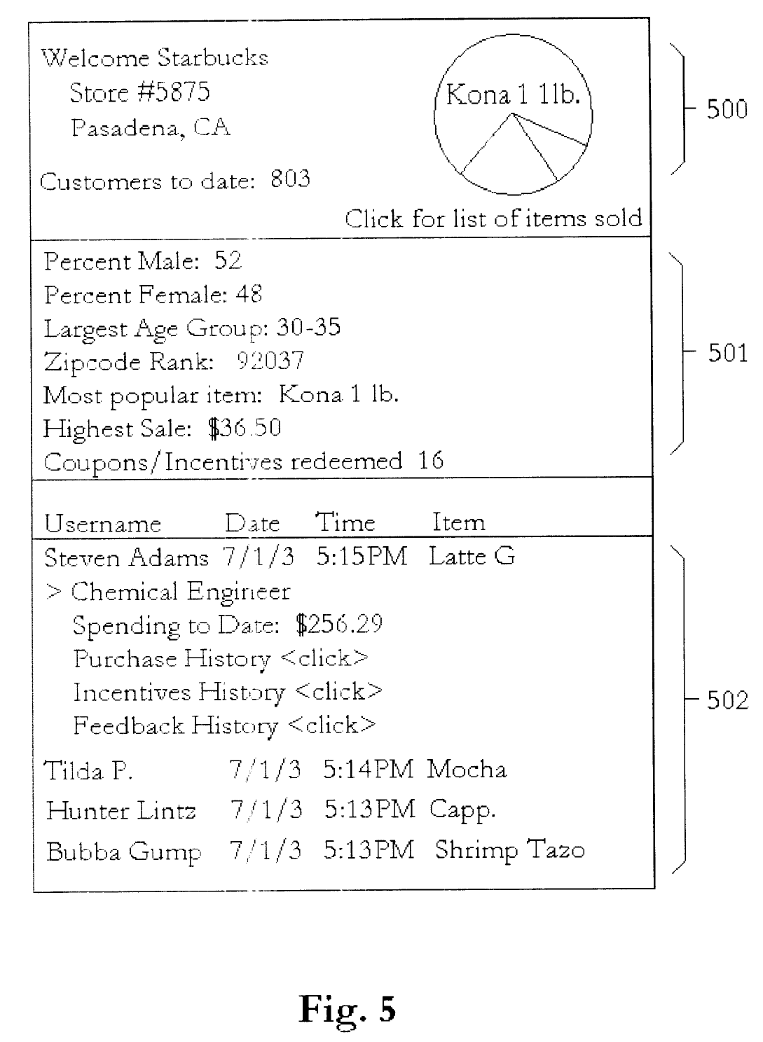

FIG. 5 shows an embodiment of the GUI as seen by a business analyst who accesses the system. The analyst is presented with a GUI that contains welcome and sales highlight section 500, summary section 501, and purchase history section 502. The welcome and sales highlight section displays the store details and shows graphically the products sold. The summary section shows sale summaries including most popular items and highest sale of the time period. The purchase history section shows the purchasers and their transaction time and in addition, the information can be drilled down into in order to determine what items the user has bought not only at this store, but may be bartered for in order to determine what other kinds of similar stores the purchaser has visited and what kinds of items that person has bought there. None of these GUI sections are required as the entire process can be automated with EDI, Web Services or any other computer to computer protocol which allows a business computer to access the purchase history of the purchase no matter where it is located. It is specifically the user”s choice to allow purchase history profile information to be accessed, including purchase history information from one business being accessible to another business. A user granting this expanded access to purchase information, (information accumulated from directly competing or possibly indirectly related businesses), would allow one coffee store to see what other coffee stores a user has visited and determine that they buy a particular item at the other store, for a given price and determine if they should offer a similar or exact product and at what price. This information may also be bartered for by the company in order to obtain that information. For example, on purchasing a coffee, the salesperson could ask the purchaser, perhaps in response to a prompt from the point of sale device, if they would like a 10% discount for their coffee related purchase history, at which time, the system would make a request for it, or mark the transaction for batch processing of the information. The purchase history could be stored on the local device of the user, or held within any of the servers in the system. The profiles may be sent in XML for compatibility purposes, and an industry standard Schema or DTD would be beneficial, although not required, by allowing comparisons of XML documents that utilize the same vernacular and in this way avoid translation of XML documents via XSLT or other method of translation.

The purchase history is the property of the purchaser, and can be sold by that purchaser and may include, but is not limited to the bar code, or RFID, or other unique identifier associated with each product, the amount paid for and the quantity of each element of the purchase. In addition the purchase history may include the name, location, date and time of purchase. An OCR reader could be employed on receipts, but stores should open their information to their customers so that they can make use of that information as they are the purchasers. Embodiments of the invention may download the purchase history information from the purchase server of the store, communications server or through a master matching server to the local device after the purchase. Any subset of this information is usable in an embodiment of the invention. The users can decide whether they want to receive marketing information or offers or opt out of any offers, or decide that they do not want to partake in selling their expanded purchase histories for any period of time, or for any reason.

An embodiment of the profile schema may comprise tags for purchase history, personal profile, activities, dating, items for sale, items needed. Many more tags may be created and utilized in order to allow many more types of profiles and elements within those profiles. In addition, attributes or tags may include time delays and incompatibility flags so that for example a user that practiced religion “A” could be set up as an automatic incompatibility for someone who desired to date a person who practiced religion “B”. Also, tags defining what elements or tags are shared by the purchaser and the business may be defined and utilized in order to allow businesses to see only those areas of the profiles that the purchaser is comfortable with sharing. An example tag of this type would be the “secret” tag. The creation of XML schemas is well known in the art, and embodiments of the invention may utilize any available DTD or schema for profile transfer, storage and comparison whether proprietary or standardized. In addition, the profile set may be binary in format or in the format of a database such as MySQL, Oracle, or any other known database or format. Embodiments of the invention may process many different types of formats of profiles as long as the embodiment contains the proper filter for decoding the profile set.

Standard web wish lists, in their native format including regular expressions for comparing, such as eBay.com “items I”m watching”, or “items I”m selling” on eBay.com may be included as well as reading lists from Amazon. Integration with websites with personal choices or items for sale or employment websites such as Monster.com can readily be achieved, but is not required for operation of the system. Examples of personal tags that may be added include every piece of information that makes up our individual histories, such as date of birth, place of birth, height, weight, color of eyes, schools attended, degrees held, places visited, activities performed including biking, running, hiking, lifting weights, skiing, sailing, ice skating, cooking, eating preferences, items for sale, items desired, jobs desired and offered, dating preferences and so on.

Examples of properties or sub-elements in an “emergency” profile may include but are not limited to “provider”, “providerType”, “serviceProvided”, “bloodType” and “allergy”. These properties could have sub-properties, implemented in XML as tags, such as “bloodTypeO”, “doctor”, “penecillinAllergy”, and any other properties desired. Further, emergency services agencies would have access to only that medical portion of a personal profile in the event of an accident requiring medical attention, and then only if it had been properly configured by that user in such a way to allow it.

Any algorithm for comparing may be utilized in order to compare two user profiles. The algorithm may comprise a loop that exists when flags notating incompatibilities exist, and the algorithm may add matches per profile or sub area and utilize these on a GUI in order to show how many items actually match. One-way or two-way algorithms may be utilized in order to perform the comparing function.

For foreign travels, receipts and other profile information may utilize language and currency translation. This enables someone finding a match while in a foreign country to see the match results in their own language. Currency conversion and payment, if the user is making a purchase, can be accomplished by a third party representative, a computer program, or any other method available and can be accomplished via a third-party representative, a computer program or any other method available.

what is claimed is:

1. A method for exchanging information comprising:
associating an identifier with a first device;
communicating said identifier to a first device reader; and,
comparing at least one first user profile associated with said first device with at least one second user profile associated with a second device.

2. The method of claim 1 wherein said communicating said identifier comprises communicating a purchase identifier.

3. The method of claim 1 wherein said communicating said identifier comprises communicating a loyalty program identifier.

4. The method of claim 1 wherein said communicating said identifier comprises communicating a cell phone identifier.

5. The method of claim 1 wherein said communicating said identifier comprises communicating a network address.

6. The method of claim 1 wherein said comparing further comprises using at least one time delay parameter.

7. The method of claim 6 further comprising scheduling said comparing based on said at least one time delay parameter.

8. The method of claim 1 wherein said comparing further comprises using a calculated geographic distance between said first device and said second device.

9. The method of claim 1 wherein said comparing further comprises using at least one time delay parameter and using a calculated geographic distance between said first device and said second device.

10. The method of claim 1 further comprising selecting a purchase method.

11. The method of claim 1 further comprising selecting a loyalty program.

12. The method of claim 1 further comprising accessing digital coupons.

13. The method of claim 1 wherein said comparing occurs on said first device.

14. The method of claim 1 wherein said comparing occurs on a central server.

15. The method of claim 1 wherein said comparing occurs on a communications server.

16. The method of claim 1 wherein said comparing occurs on a comparing server.

17. The method of claim 1 wherein said comparing is accomplished via a Web Service.

18. The method of claim 1 further comprising offering a discount to a purchaser for at least one piece of information within said at least one first user profile.

19. The method of claim 1 wherein said at least one first user profile comprises a purchase history profile.

20. The method of claim 1 further comprising obtaining said at least one first user profile and evaluating said at least one first user profile for purposes of making a business decision.

21. The method of claim 1 further comprising storing a purchase receipt in said first device.

22. The method of claim 1 further comprising storing a purchase receipt in a central server.

23. The method of claim 1 further comprising storing a purchase receipt in a communications server.

24. The method of claim 1 further comprising storing a purchase receipt in a comparing server.

25. The method of claim 1 further comprising transmitting a match result to said first device and alerting a user associated with said at least one first user profile of a match.

26. The method of claim 1 further comprising storing a match result on a server.

27. The method of claim 1 further comprising obtaining payment in exchange for access to said first device reader.

28. The method of claim 1 further comprising obtaining payment in exchange for access to said at least one first user profile.

29. The method of claim 1 wherein communicating an identifier comprises using a wireless connection.

30. The method of claim 1 wherein said communicating said identifier comprises using a cell phone connection.

31. The method of claim 1 wherein said communicating said identifier comprises using a Bluetooth (™) connection.

32. The method of claim 1 wherein said communicating said identifier comprises using a WiFi connection.

33. The method of claim 1 wherein said communicating said identifier comprises using an ultrasonic connection.

34. The method of claim 1 wherein said communicating said identifier comprises using an IR connection.

35. The method of claim 1 wherein said communicating said identifier comprises using a biometric device.

36. The method of claim 1 wherein said communicating said identifier comprises physical contact.

37. The method of claim 1 wherein said communicating said identifier comprises using an RFID device.

38. A system for exchanging information comprising:
a plurality of devices;
at least one device reader capable of communicating with said plurality of devices;
a profile database comprising a first at least one profile per a first associated user;
a server configured to compare said first at least one profile with a second at least one profile per a second associated user and produce a match result wherein said server is coupled with said profile database and is configured to obtain information from said at least one device reader; and,
a plurality of computers coupled to said server via a communications network.

39. The system of claim 38 wherein said first at least one profile comprises at least one time delay parameter and said server is configured to calculate a geographic distance between said plurality of devices.

40. The system of claim 38 wherein said plurality of devices comprise a credit card.

41. The system of claim 38 wherein said plurality of devices comprise a smart card.

42. The system of claim 38 wherein said plurality of devices comprise a cash card.

43. The system of claim 38 wherein said plurality of devices comprise a loyalty card.

44. The system of claim 38 wherein said plurality of devices comprise an RFID device.

45. The system of claim 38 wherein said plurality of devices comprise a cell phone.

46. The system of claim 38 wherein said plurality of devices comprise a PDA.

47. The system of claim 38 wherein said plurality of devices comprise a text messaging device.

48. The system of claim 38 wherein said plurality of devices comprise a communications device.

49. The system of claim 38 wherein said plurality of devices comprise human biometric input.

50. The system of claim 38 wherein said plurality of profiles comprise a purchase history profile.

51. The system of claim 38 wherein said plurality of profiles comprise a dating profile.

52. The system of claim 38 wherein said plurality of profiles comprise an employment profile.

53. The system of claim 38 wherein said plurality of profiles comprise a for-sale profile.

54. The system of claim 38 wherein said plurality of profiles comprise a wanted-item profile.

55. The system of claim 38 wherein said plurality of profiles comprise a loyalty profile.

56. The system of claim 38 wherein said plurality of profiles comprise a coupons profile.

57. The system of claim 38 wherein said plurality of profiles comprises an emergency services and needs profile.

58. The system of claim 38 wherein said plurality of profiles comprises a feedback profile.

59. A system for exchanging information comprising:
a first device and a second device capable of directly communicating;
a first at least one profile per a first associated user of said first device;
a second at least one profile per a second associated user of said second device wherein said first device is configured to compare said first at least one profile with said second at least one profile and produce a match result.

60. The system of claim 59 wherein said first device is capable of communicating with a device reader.

61. The system of claim 59 wherein said first device is capable of storing business transactions into a purchase history profile.
